(19) United States
(12) Patent Application Publication
(10) Pub. No.: US 2016/0037068 A1
(43) Pub. Date: Feb. 4, 2016

(54) SYSTEM AND METHOD OF STITCHING TOGETHER VIDEO STREAMS TO GENERATE A WIDE FIELD VIDEO STREAM

(71) Applicant: GOPRO, INC., San Mateo, CA (US)

(72) Inventors: Alexandre JENNY, Challes-les-Eaux (FR); Renan COUDRAY, Montmelian (FR)

(73) Assignee: GOPRO, INC., SAN MATEO, CA (US)

(21) Appl. No.: 14/880,879

(22) Filed: Oct. 12, 2015

Related U.S. Application Data
(63) Continuation of application No. PCT/EP2014/057352, filed on Apr. 11, 2014.

(30) Foreign Application Priority Data
Apr. 12, 2013 (FR) 1353346

(51) Int. Cl. H04N 5/232; H04N 5/247; H04N 5/265

(52) U.S. Cl. CPC H04N 5/23238; H04N 5/23229; H04N 5/265; H04N 5/247

(57) ABSTRACT

Video streams may be stitched together to form a single wide field video stream. The wide field video stream may exhibit a view with a field angle that may be larger than a field angled of an individual video stream. The wide field video stream may exhibit, for example, panoramic views. A method of stitching together video stream may comprise one or more of determining at least one reference time instance within a reference video stream; determining a first set of values of parameters used to generate a first panoramic image that comprises a combination of images that correspond to the at least one reference time instance; generating panoramic images that comprise images of individual video streams based on the first set of values of the parameters; and/or other operations.

### FIELD OF THE DISCLOSURE

This disclosure relates to stitching together video streams to generate a wide field video stream.

### BACKGROUND

Existing cameras make it possible to generate a data file of a video type. Such a file may correspond to a video steam comprising a view of an environment limited by the field angle of the camera, which may be, for example, about 170 degrees. To obtain a wider and more complete vision of the environment, especially amply exceeding the human visual field of vision, a plurality of cameras may be used simultaneously. The cameras may be oriented in different directions, so as to obtain a plurality of complementary video streams of the environment at the same instance. However, utilization of these various video streams to generate a single video, referred to as a wide field video stream, may not be easy with existing solutions. By way of non-limiting example, generating the wide field video stream may comprise combining video streams together to generate the single wide field video. The wide field video may exhibit a view with large field angle, for example of a panoramic view. This combination process, sometimes referred to as “stitching” is, however, not optimized in current techniques and may not make it possible to obtain a wide field video stream of satisfactory quality. Indeed, some stitching techniques requires numerous manual operations by a user, the use of a plurality of separate and not directly compatible software tools, thus requiring significant time, is not user-friendly, and entails a significant loss of quality at the video level.

Document U.S. Patent No. 2009/262206 proposes, for example, a juxtaposition of frames of video streams, as a function of geometric criteria related to the relative positions of a plurality of cameras. These criteria are established automatically at the start of the juxtaposition process. This solution does not implement a stitching of video streams but a simple juxtaposition, which may not yield high quality since a discontinuity inevitably occurs at the level of the boundaries between the various video streams.

### SUMMARY

One aspect of the disclosure relates to a method of stitching together video streams to generate a wide field video stream. In some implementations, the method may comprises one or more of the following operations: determining at least one reference time instance within a reference video stream; determining a first set of values of parameters used to generate a first panoramic image, the first panoramic image comprising a combination of images from individual video streams that correspond to the at least one reference time instance; generating panoramic images that comprise combinations of images of individual video streams that correspond to individual time instances within the video streams, wherein the panoramic images may be generated based on the first set of values of the parameters; and/or other steps. In some implementations, individual ones of the generated panoramic images may comprise a frame of the wide field video stream. In some implementations, a reference video stream may comprise a video stream with which other ones of the video streams may be synchronized to.

In some implementations, the method of stitching together video streams to generate a wide field video stream may comprise one or more of the following operations: determining, by user input into a user interface, a reference time instance within a reference video stream; determining a first set of values of parameters used to generate a first panoramic image, the first panoramic image comprising a combination of images from individual video streams that correspond to the reference time instance; generating panoramic images that comprise combinations of images of individual video streams that correspond to individual time instances within the video streams, wherein the panoramic images may be generated based on the first set of values of the parameters; and/or other steps. In some implementations, individual ones of the generated panoramic images may be provided as a frame of the wide field video stream.

In some implementations, the method of stitching together video streams to generate a wide field video stream may comprise one or more of the following operations: determining, automatically or by user input into a user interface, a first reference time instance within a reference video stream; determining a set of reference time instances distributed around the first reference time instance; determining intermediate sets of values of parameters used to generate intermediate panoramic images, individual ones of the intermediate panoramic images comprising a combination of images from individual video streams that correspond to individual ones of the reference time instances in the set of reference time instances; determining a first set of values of the parameters based on averaging the values included in the intermediate sets of values for individual ones of the parameters; generating panoramic images that comprise combinations of images of individual video streams that correspond to individual time instances within the video streams, wherein the panoramic images may be generated based on the first set of values; and/or other operations.

In some implementations, the method of stitching together video streams to generate a wide field video stream may comprise one or more of the following operations: determining, automatically or by input into a user interface, a plurality of reference time instances within a reference video stream, the plurality of reference time instances being within a predetermined time period of the reference video stream; determining intermediate sets of values of parameters used to generate intermediate panoramic images, individual ones of the intermediate panoramic images comprising a combination of images from individual video streams that correspond to individual ones of the reference time instances in the plurality of reference time instances; determining a first set of values of the parameters based on combining values included in the intermediate sets of values for individual ones of the parameters; generating the panoramic images that comprise combinations of images of individual video streams that correspond to individual time instances within the video streams, wherein the panoramic images may be generated based on the first set of values; and/or other operations. In some implementations, a combination of values may comprise averaging the values and/or performing other calculations.

In some implementations, the method of stitching together video streams to generate a wide field video stream may comprise one or more of the following operations: obtaining user selection of a reference time instance within a reference video stream via a user interface; presenting a panoramic image that comprises a combination of images within the video streams at the obtained reference time instance in a window of the user interface; and/or other operations.

In some implementations, the method of stitching together video streams to generate a wide field video stream may comprise repeating one or more of the following operations for individual time instances and/or sets of time instances sequentially over a duration of a reference video stream: decoding, from the video streams, individual images corresponding to a given time instance within the individual video streams; generating a given panoramic image using decoded images that correspond to the given time instance; generating the wide field video stream by providing the given panoramic image as a given frame of the wide field video stream; and/or other operations. In some implementations the method of stitching together video streams to generate a wide field video stream may further comprise an operation of video coding the wide field video stream either at the end of each iteration of the repeated operations, or at the end of a set of iterations.

In some implementations, the method of stitching together video streams to generate a wide field video stream may comprise one or more of the following operations: determining a temporal offset between individual ones of the video steams based on audio information associated with individual ones of the video streams, the determination being based on identifying an identical sound within audio information of the video streams; synchronizing the video streams based on the temporal offset by associating individual images within individual video streams with other individual images within other ones of the individual video streams that may be closest in time; and/or other operations.

In some implementations, the method of stitching together video streams to generate a wide field video stream may comprise an operation of receiving user selection of one or both of a reference start time instance and/or a reference end time instance within a reference video stream via a user interface.

In some implementations, the method of stitching together video streams to generate a wide field video stream may comprise an operation of associating audio information of at least one of the video streams with the wide field video resulting from the generation of panoramic images.

Another aspect of the disclosure relates to a device configured for stitching together video streams to generate a wide field video stream. The device may include one or more of one or more processors, a memory, and/or other components. The one or more processors may be configured by machine-readable instructions. Executing the machine-readable instructions may cause the device to implement one or more the operations of one or more implementations of the method of stitching together video streams to generate a wide field video stream as presented herein.

Yet another aspect of the disclosure relates to a user interface configured to facilitate stitching together video streams. The user interface may be configured to receive user selection of a reference time instance used for determining values of parameters for generating panoramic images, and/or other user input.

In some implementations, the user interface may include interface elements comprising one or more of: a first window configured for presenting video streams to be stitched and/or having a functionality enabling video streams to be added or removed; a one or more elements configured for receiving input of user selection of start and/or end reference time instances within a reference video stream; a second window configured for viewing a panoramic image generated from images of various video streams at a reference time instance; a third window configured for presenting a wide field video representing panoramic images generated for other time instances in the synchronized video streams; and/or other interface components.

Still another aspect of the disclosure relates to a system configured for stitching video streams. The system may comprise one or more of a device configured for stitching together video streams to generate a wide field video stream, a multi-camera holder comprising at least two housings for fastening cameras, and/or other components. The multi-camera holder may be configured to fasten cameras such that at least two adjacent cameras may be oriented substantially perpendicular to one other.

In some implementations, the system for stitching video streams may further comprise a reader configured to read a video coded format of the wide field video stream to facilitate presentation of the wide field video stream on a display.

Still yet another aspect of the disclosure relates to a method for stitching a plurality of video streams characterized in that it comprises one or more of the operations of one or more of the implementations of the method presented above and further comprising one or more of the following operations: positioning at least one multi-camera holder in an environment; capturing a plurality of video streams from cameras fastened on the at least one multi-camera holder; stitching the plurality of video streams according to one or more operations described above; presenting, on at least one display space of at least one display screen, a wide field video that results from the stitching; and/or other operations. In some implementations, positioning the at least one multi-camera holder in an environment may comprise one or more of level with an event stage, in a sporting arena, on an athlete during a sporting event, on a vehicle, on a drone, and/or on or a helicopter.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured for stitching video streams, in accordance with one or more implementations.

FIG. 2 illustrates a method of stitching video streams, in accordance with one or more implementations.

FIG. 3 illustrates a user interface configured to receive user input to facilitate stitching video streams, in accordance with one or more implementations.

### DETAILED DESCRIPTION

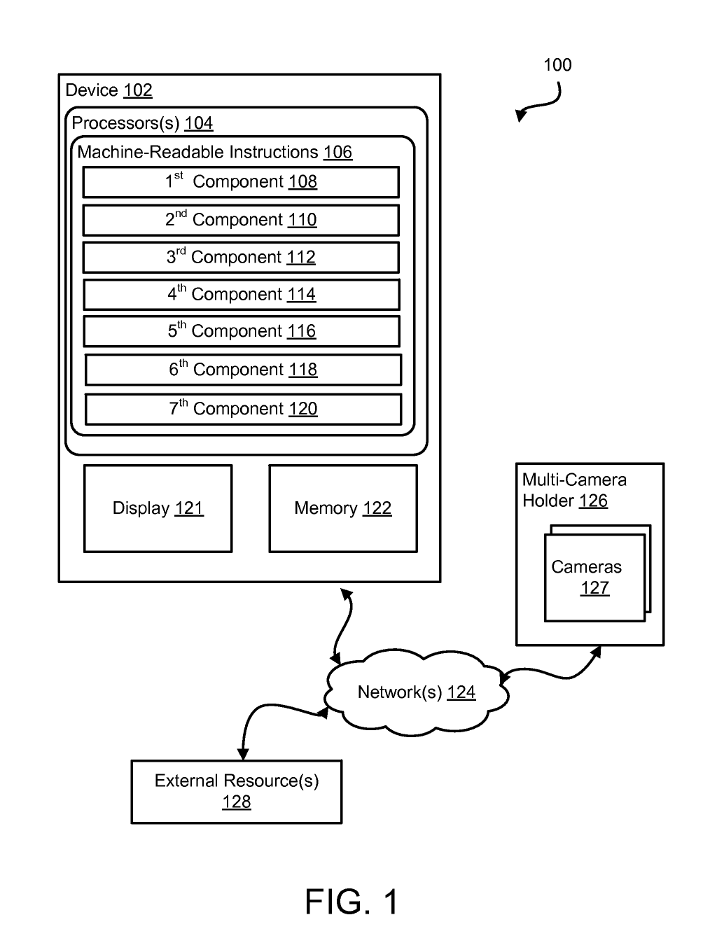

FIG. 1 illustrates a system 100 configured for stitching together video streams to generate a wide field video stream, in accordance with one or more implementations. Individual video streams may be represented by one or more of visual information, audio information, and/or other information. The visual information may comprise images captured by a camera in a real-world environment. Audio information may comprise sounds captured by the a camera prior to, during, and/or post capture of the visual information.

Individual video streams may comprise a view of an environment that may be limited by a field angle of the camera. Stitching together video streams may facilitate generating a wide field video stream that comprises a view of the environment that may be greater than any individual video stream captured by an individual camera. One or more operations for stitching may be automatically optimized to make it possible to guarantee satisfactory quality of the resultant wide field video steam. One or more implementations of method of stitching together video streams may comprise one or more operations of receiving manual intervention of a user through a user-friendly user interface. The resultant wide field video stream may represents a compromise of one or more manual interventions by a user and of automatic operations. The resultant video may have optimal quality that may be generated in a fast and user-friendly manner for the user. It is noted the term “video stream” used in a simplified manner may also refer to an audio-video stream including both audio information and video information. In some implementations, the wide field video stream may include the audio information of at least one of the video streams and/or supplemental audio information (e.g., a song) that may be provided in parallel with stitching operations.

In FIG. 1, system 100 may comprise one or more of a device 102 configured for stitching together video streams to generate a wide field video stream, a multi-camera holder 126, a plurality of cameras 127, one or more networks 124, one or more external resources 128, and/or other components. The device 102 may include one or more of a server, a cellular telephone, a smartphone, a digital camera, a laptop, a tablet computer, a desktop computer, a television set-top box, smart TV, a gaming console, and/or other platforms.

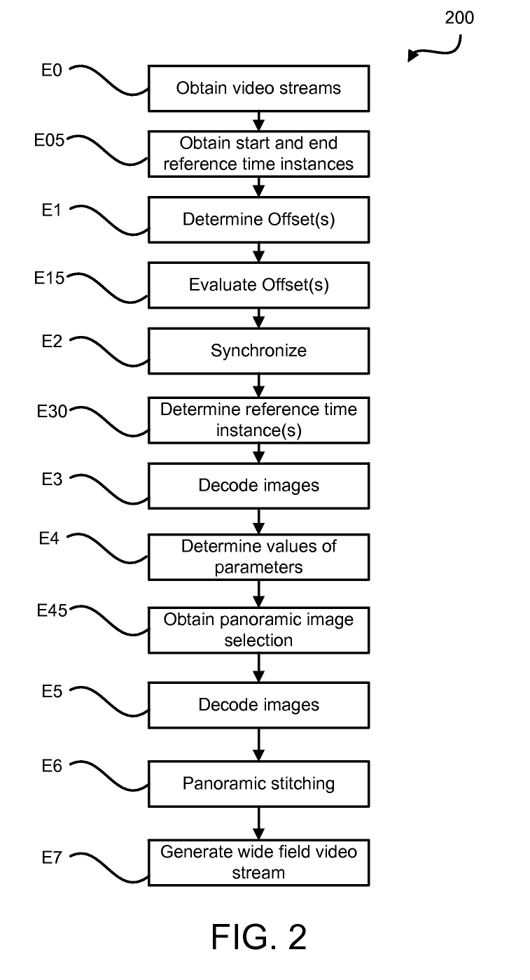

The device 102 may include one or more of one or more physical processors 104 configured by machine-readable instructions 106, a display 121, a memory 122, an input (not shown in FIG. 1), an output (not shown in FIG. 1), and/or other components. Executing the machine-readable instructions 106 may cause the one or more physical processors 104 to facilitate stitching together video streams to generate a wide field video stream. The machine-readable instructions 106 may include one or more of a first component 108, a second component 110, a third component 112, a fourth component 114, a fifth component 116, a sixth component 118, a seventh component 120, and/or other components. Individual ones of the components of machine-readable instructions 106 may be configured to implement one or more operations of method 200 of stitching together video streams as shown in FIG. 2, and/or other operations.

In FIG. 1, in some implementations, various video streams may be captured by plurality of cameras 127 fastened on multi-camera holder 126. The multi-camera holder 126 may be configured to mount and/or otherwise fasten a plurality of cameras to facilitate capturing a plurality of views from one or more viewpoints. The multi-camera holder 126 may be configured to mount and/or otherwise fasten plurality of cameras 127 with a fixed orientation between individual ones of the cameras 127. By way of non-limiting example, multi-camera holder 126 may be configured to fasten six cameras and/or other amounts of cameras. In some implementations, individual axes of the fields of vision of two adjacent cameras may be oriented in substantially perpendicular directions, thereby making it possible to obtain a 360 degree view of an environment around multi-camera holder 126 and/or some other picture-taking point. In some implementations, multi-camera holder 126 may be configured such that various cameras 127 may be fixed with respect to one another. In some implementations, multi-camera holder 126 may be configured such that various cameras 127 may be movable with respect to one another.

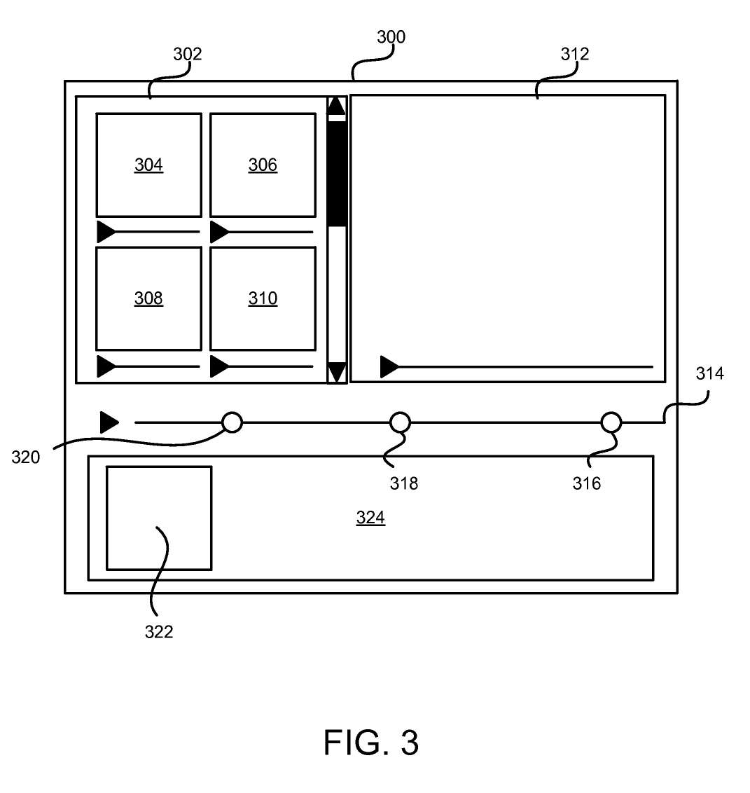

In some implementations, first component 110 may be configured to implement an operation E0 and/or other operations of method 200 in FIG. 2. Operation E0 may comprise obtaining video streams to be stitched together to generate a wide field video. In some implementations, video streams may be obtained based on one or more of user selection of the video streams via a user interface (see, e.g., FIG. 3), automatically as the video streams are captured by the cameras 127, automatically following the capture of the video streams by the cameras 127, and/or other techniques.

In some implementations, first component 110 may be configured to implement an operation E05 and/or other operations of method 200 in FIG. 2. Operation E05 may comprise determining one or both of a reference start time instance and/or a reference end time instance within a reference video stream. By way of non-limiting example, a reference video stream may comprise a video stream with which other ones of the video streams may be synchronized to. In some implementations, determining one or both of a reference start time instance and/or a reference end time instance may comprising obtaining user selection of one or both of the reference start time instance and/or the reference end time instance via a user interface (see, e.g., user interface 300 in FIG. 3).

In some implementations, first component 110 may be configured to implement operation E1 of the method 200 in FIG. 2, and/or other operations. In some implementations, multi-camera holder 126 may mount cameras 127 that may be independent from each other and/or may operate with independent clocks. Thus, individual streams captured by individual ones of the cameras 127 may be offset in time. This offset may be caused, for example, by one or more of different instances of startup of individual ones of the cameras 127, a separate temporal reference of the cameras, a slipping offset due to differences of internal clock of the cameras, and/or other factors.

In some implementations, operation E1 of method 200 in FIG. 2 may comprise determining temporal offsets between two or more video streams, and/or other operations. By way of non-limiting example, temporal offsets may be determined between pairs of video streams. By way of non-limiting example, offsets may be determined between individual ones of the video streams and a reference video stream.

In some implementations, operation E1 may be performed based on audio information of individual ones of the video streams, and/or by other techniques. In some implementations, determining temporal offsets between two or more video streams may comprise one or more of identifying an identical sound (or sounds) from the audio information of the individual video streams, determining a temporal offset between the occurrence of the identical sound within the video streams, deducing from the temporal offsets of the identical sound the temporal offsets of the video streams, and/or other operations.

In some implementations, a search within audio information to identify a particular sound and thereby deduce therefrom offsets between two or more video streams may be limited about a reference time instance indicated by a user. By way of non-limiting example, a user may provide input of a selection of a reference time via a user interface. The selection of a reference time may be the same or similar to operations describe with respect to operation E30 (see, e.g., FIG. 2). In some implementations, the search for the identical sound may be entirely automatic. In some implementations, searching for an identical sound may be carried out over a duration of a given video stream.

In some implementations, first component 108 and/or other components may be configured to implement operation E15 of method 200 in FIG. 2, and/or other operations. Operation E15 may comprise evaluating the determined offsets, and/or other operations. In some implementations, evaluating the determined offsets may be based on detecting incoherence between the offsets determined for the individual sets of two or more video streams. In some implementations, operation E15 may further comprise transmitting the result of this evaluation to a user a user interface and/or determining automatically that a result may be satisfactory or unsatisfactory.

By way of non-limiting example, evaluating the offsets may comprise performing a comparison of individual ones of the offsets with a predefined offset threshold, and/or other techniques for evaluating. If a given offset meets or exceeds a threshold amount, it may be determined that the offset is unsatisfactory. In some implementations, a new offset may be employed in case the result should be unsatisfactory. By way of non-limiting example, the new offset may be determined based on identifying another identical sound (or sounds) between video streams.

In some implementations, second component 110 may be configured to implement operation E2 of method 200 in FIG. 2, and/or other operations. Operation E2 may comprise inverse offsetting video streams to achieve synchronization. By way of non-limiting example, a video stream may be selected as a reference video stream. The reference video stream may be the video stream having the latest start time. Other ones of the video streams may be synchronized with this reference video stream.

In some implementations, offsets obtained in operation E1 between individual ones of the video streams and the reference video stream may be used to deduce therefrom a number of offset images (e.g., frames) for individual video streams with respect to the reference video stream. Individual video streams may be inversely offset by the number of offset images so as to obtain its synchronization with the reference video stream. Synchronizing video streams to a reference video stream based on a temporal offset may further comprise associating individual images within individual video streams (e.g., corresponding to individual frames of the video streams) with other individual images within the reference video stream that may be closest together in time and/or associated with the same time instance.

In some implementations, the audio information of individual video streams may be likewise offset by the same or similar offset time determined at operation E1. The audio information may be synchronized based on the determined offsets.

In some implementations, if video streams are already synchronized, one or more of operations E1, E15, and/or E2 may not be performed. By way of non-limiting example, a holder of multiple cameras may integrate a common clock that may manage the various cameras such that the output video streams may be synchronized.

In some implementations, one or both of third component 112 and/or fourth component 114 may be configured to implement one or more of operations E30, E3, E4, E45, and/or other operations of the method 200 illustrated in FIG. 2. Implementation of one or more of operations E30, E3, E4, and/or E45 may facilitate operations related to determining values of one or more parameters used in the generation of panoramic images, and/or other operations.

In FIG. 2, at an operation E30, at least one reference time instance within the reference video stream may be determined. In some implementations, the at least one reference time instance may comprise a single reference time instance. In some implementations, the at least one reference time instance may comprise a plurality of reference time instances. In some implementations, a plurality of reference time instances may be determined within a predetermined time period of the reference video stream. In some implementations, a plurality of reference time instances may comprise a set of reference time instances distributed around the first reference time instance.

By way of non-limiting example, the at least one reference time instance may comprise a first reference time instance. By way of non-limiting example, the at least one reference time instance may comprise a first plurality of reference time instances. The first plurality of reference time instances may be within a first predetermined time period of a reference video stream.

At an operation E3, individual images corresponding to the at least reference time instance within individual ones of the synchronized video streams may be decoded from the various respective video streams. In some implementations, decoding may comprise transforming the electronically stored visual information of the video streams, which may be initially in a given video format such as MPEG, MP4, and/or other format, to a different format configured to facilitate one or more subsequently processing operations. By way of non-limiting example, individual images may be decoded from a first format to a second format. The first format may comprise one or more of MPEG, MP4, and/or other formats. The second format may comprise one or more of jpg, png, tiff, raw, and/or other formats.

At an operation E4, values of parameters for generating one or more panoramic images from the decoded images may be determined. The values may be stored for use in one or more subsequent stitching operations. In some implementations, operation E4 may further comprise generating the one or more panoramic images based on values of parameters determined using the decoded images resulting from operation E3. In some implementations, for the generation of a panoramic image, the method may employ one or more techniques that may depend on one or more values of one or more parameters. By way of non-limiting example, generating a panoramic image may include one or more operations described in U.S. Pat. No. 6,711,293. By way of non-limiting example, a technique for generating a panoramic image may include a panoramic image generation algorithm. In some implementations, a panoramic image generation algorithm and/or other technique to generate a panoramic image may depend on values of one or more parameters. Values of parameters used to generate a panoramic image may be determined from one or more of the images, camera settings, and/or other information.

By way of non-limiting example, parameters used to generate a panoramic image may include one or more of a positioning parameter, a camera parameter, a color correction parameter, an exposure parameter, and/or other parameters. Values of a positioning parameter may include one or more of a relative position of individual cameras with respect to other ones of the cameras, and/or other information. Values of camera parameters may include one or more of an image distortion, a focal length, an amount of sensor/lens misalignment, and/or other information. Values of color correction parameters may be related to color filters applied to images, and/or other information. Values of exposure parameters may include an exposure associated with images, and/or other information. The above description of parameters used to generate panoramic images and/or their values is provided for illustrative purposes only and is not to be considered limiting. For example, other parameters may be considered when generating a panoramic image.

During panoramic image generation, multiple images may be combined so as to form a single image. The forming of the single image may comprise managing intercut zones of the various images. By way of non-limiting example, a plurality of cameras may have captured visual information from common zones of an environment, referred to as intercut zones. Further, individual cameras may have captured visual information from a zone that may not have been captured by other cameras, referred to as non-intercut zones. Forming a single image may further comprise processing boundaries between images originating from various cameras so as to generate a continuous and visually indiscernible boundary.

By way of non-limiting illustration, operation E4 may comprise determining a first set of values of parameters used to generate a first panoramic image. The first panoramic image may comprise a combination of images from individual video streams that correspond to a first reference time instance (e.g., determined at operation E3). For example, the first panoramic image may comprise a combination of a first image from a first video stream that corresponds to the first reference time instance, a second image from a second video stream that corresponds to the first reference time instance, and/or other images from other video streams that correspond to the first reference time instance. The first set of values of parameters may be determined based on one or more of the first image, the second image, and/or other images from other video streams that correspond to the first reference time instance. The first set of values may be stored for use in subsequent stitching operations

In some implementations, values of panoramic images may be determined using other techniques when the at least one reference time instances comprises a plurality of reference time instances. By way of non-limiting example, for individual ones of the reference time instances in a plurality of reference time instances, intermediate sets of values of parameters used to generate intermediate panoramic images may be determined. Individual ones of the intermediate panoramic images may comprise a combination of images from individual video streams that correspond to individual ones of the reference time instances in the plurality of reference time instances. From the intermediate sets of values of the parameters, a single set of values of the parameters may be determined that may comprise a combination of values in the intermediate sets of values for individual ones of the parameters. In some implementations, a combination may comprise one or more of an averaging, a mean, a median, a mode, and/or other calculation to deduce a final value for individual parameters on the basis of the values in the intermediate sets of values.

In some implementations, a plurality of reference time instances may comprise a plurality of time instance selected over a time span distributed around a single reference time instance. In some implementations, the time span may be determined by one or more of a predetermined duration, a predetermined portion before and/or after the single reference instant, by user input, and/or by other techniques.

In some implementations, a plurality of reference time instances may be selected over a predefined period over all or part of a duration selected for the wide field video stream (e.g., a duration between a reference start time and reference end time selected with respect to a reference video stream).

In some implementations, one or more reference time instances may be determined based on a random and/or fixed selection according to one or more rules.

In some implementations, a reference time instance may not comprise a reference start time instance.

In some implementations, one or more operations of method 200 implemented by one or more components of machine-readable instructions 106 of device 102 may comprise evaluating the panoramic image generated according to operations E30, E3, and/or E4. In some implementations, an evaluation may be either automatic or provided as an option to a user via presentation on a user interface. By way of non-limiting example, the generated panoramic image may be presented to a user via the user interface. The user interface may be configured to receive user input to modify one or more of the values of parameters used for generating the panoramic image, the reference time instance, and/or other factors. The user modification(s) may facilitate one or more new implementations of operations E30, E3, and/or E4 to generate one or more new panoramic images.

In some implementations, where a plurality of panoramic images have been generated, a user may provide input of selection of at least one of the plurality of panoramic images. The user selection may facilitate storing values of parameters associated with the generation of the selected panoramic image. By way of non-limiting example, a user selection of a panoramic image may facilitate implementation of operation E45 of method 200 (see, e.g., FIG. 2).

By way of non-limiting example, a first set of values of parameters may be used to generate a first panoramic image. A quality of the first panoramic image may be evaluated. By way of non-limiting example, the evaluation may be performed by a user who views the first panoramic image via a user interface. In some implementations, responsive to the quality of the first panoramic image being unsatisfactory, at least one other reference time instance within a reference video stream may be determined. A second set of values of parameters used to generate a second panoramic image may be determined. The second panoramic image may comprise images from individual video streams that correspond to the at least one other reference time instance. A quality of the second panoramic image may be evaluated. Responsive to the quality of the second panoramic image being satisfactory such that the user provides selection of the second panoramic image and not the first panoramic image, the second set of values and not the first set of values may be stored and used for one or more subsequent stitching operations, presented herein.

Stitching video streams may correspond to a scheme that may facilitate combining the visual and/or audio information originating from a plurality of cameras corresponding to the intercut zones, so as to obtain a result which is continuous through these intercut zones and of optimal quality. By way of non-limiting example, a pixel of an image representing visual information of an intercut zone may be constructed on the basis of the visual information originating from a plurality of cameras, and not through visual information of only a single camera. In some implementations, a juxtaposition of visual information may not represent “stitching” within the meaning of the disclosure. In this approach, stitching may implement complex calculations, a transformation using the values of the parameters used to generate panoramic images so as to take account of the differences in color and/or exposure between the images originating from the various cameras, and/or other operations. By way of non-limiting example, values of exposure parameters may be used to level the exposure of individual ones of the image to get a smooth and consistence exposure in a panoramic image.

In some implementations, the method 200 may utilize one or more video stream stitching operations to obtain, at output, a single wide field video stream. The wide field video stream may comprise an aggregate of video information originating from multiple video streams. Accordingly, a resulting wide field video stream may be exhibit a field of vision that depends on the fields of video of the individual video streams considered at input. Likewise, the term “panoramic image” may be used to refer to an image obtained by combining a plurality of images, the result being able to form a wide angle of view, but in a non-limiting manner.

In stitching operations presented below, device 102 may implement a repetition of one or more of operations E5-E7, over the whole (or part) of a duration of a reference video stream. By way of non-limiting example, one or more operations presented below may be performed in a first iteration which addresses a limited amount of time instances within the video streams. A subsequent iteration of the operations may continue which addresses another limited amount of time instances that follow the time instances addressed in the previous iteration. Additional iterations may be performed until a desired duration of the output wide field video may be achieved.

At a operation E5, one or more images may be decoded for individual video streams at one or more time instances within the video streams. Operation E5 may be implemented in fifth component 116 of machine-readable instructions 106 of device 102 in FIG. 1. The decoded images may be stored in a memory 122 of device 102 for their processing in one or more subsequent operations. In some implementations, the decoding may be limited to a predefined amount of images corresponding to a predefined amount of time instances per video stream. By way of non-limiting example, the predefined amount may comprise one or more of ten or fewer, three or fewer, and/or other amounts of images (e.g., time instances) per video stream. The limited amount of decoded images in a given iteration may be advantageous because this may not demand a large memory size at the given iteration. For example, individual video streams may be stored with minimal memory usage due to its video coded standard format, which may integrate a data compression scheme. However, a decoded format of a video stream which facilitates processing the video stream in accordance with one or more operations presented herein may use relatively more memory.

In FIG. 2, at an operation E6 panoramic images may be generated from the decoded images (e.g., referred to as “panoramic stitching” in FIG. 2). This may be implemented in sixth component 116 of machine-readable instructions 106 of device 102 (FIG. 1). Operation E6 may comprise combining decoded images from individual ones of the video streams that correspond to a given instance where images have been decoded from the video streams in operation E5. For example, the generated panoramic images may comprise decoded images from individual video streams that correspond to individual time instances included in the limited, and predefined amount of time instances from operation E5. This generation of the panoramic images may be carried out based on the stored values of parameters (e.g., as determined by steps E30, E3 and/or E4 described above).

At an operation E7, a wide field video may be generated. This step may be implemented by seventh component 10 of machine-readable instructions 104 of device 102 in FIG. 1. By way of non-limiting example, individual ones of generated panoramic images may be provided as a frame of the wide field video stream. The wide field video may be encoded in a desired video format. By way of non-limiting example, the video format of the wide field video may comprise one or more of MPEG, MP4, H264, and/or other formats. In some implementations, the wide field video stream may be encoded to the video format either at the end of each iteration of the repeated operations E5-E7, or at the end of a set of multiple iterations.

In some implementations, iterating steps E5 to E7 over a given duration may allow for a progressive construction of the wide field video stream. In this matter, decoding the entirety of the video streams at once may be avoided. As mentioned previously, decoding an entire video stream may require a very large memory space in device 102. This may also make it possible to avoid storing the whole of the resulting wide field video stream in a likewise bulky format, since only a small part of the output wide field video stream may remain in the memory of device 102 in a decoded format. Thus, with the advantageous solution adopted, only a few images may be decoded and processed at each iteration, thus requiring only a small memory space, as well as reasonable calculation power. The various video streams and the wide field video stream as a whole may be stored in a standard encoded video format, for example MPEG, which occupies a standardized, compressed memory space designed to optimize the memory space of a computing device.

By way of non-limiting example, iterating operations E5-E7 may comprise repeating one or more following operations sequentially individual time instances and/or sets of time instances within the video streams: decoding, from the video streams, individual images corresponding to a given time instance and/or set of time instances within the individual video streams; generating a given panoramic image using decoded images from the individual video streams that correspond to the given time instance and/or set of time instances; generating the wide field video stream by providing the given panoramic image as a given frame of the wide field video stream; and/or other operations. By way of non-limiting example, the method may further comprise an operation of video coding the wide field video stream either at the end of each iteration of the repeated operations, or at the end of a set of iterations.

In some implementations, during the encoding of the wide field video, audio information associated with one or more video streams may be encoded with visual information of the wide field video stream. As such, the wide field video may comprise both visual information (e.g., associated with the generation of panoramic images) and audio information.

In FIG. 1, device 102 may be configured to transmit wide field video stream via an output, for example, to an exterior reader configured to read a video coded format of the wide field video to facilitate presentation on a display. In some implementations, device 102 may comprise an integrated reader (not shown in FIG. 1) configured to facilitate presentation of the wide field video stream on display 121 of device 102.

A complementary technical problem may arise in respect of one or more implementations of method 200 in FIG. 2 for stitching video streams described herein, and implemented by stitching device 102. Indeed, in one or more implementations, one or more operations may propose an intervention by an user. It may be necessary to render this intervention optimal and user-friendly. Accordingly, a solution may further rest upon a user interface, with the aid of machine-readable instructions 106 implemented by the one or more processors 104 of device 102 and allowing exchanges with an user by way of one or more of display 121, one or more input mechanisms (not shown), and/or other components.

FIG. 3 depicts an exemplary implementation of a user interface 300. The user interface 300 may comprise user interface elements including one or more of a first window 302, a second window 324, a third window 312, a timeline 314, a first adjustable element 316, a second adjustable element 318, a third adjustable element 320, and/or other user interface elements.

In some implementations, first window 302 may be configured to receive user input of a selection of video streams to be stitched. By way of non-limiting example, a user may provide input of adding and/or removing video streams to first window 302 through one or more of a drop down menu, check boxes, drag-and-drop feature, browse feature, and/or other techniques. By way of non-limiting example, a user may employ one or more of a manual browse in memory space of the device 102 to select video streams to be added, select via another window (e.g., a pop up window) and move video streams into first window 302 via drag-and-drop, and/or employ other techniques. A user may delete video streams from first window 302, for example, via one or more of a delete button (not shown in FIG. 3), by moving them manually via drag-and-drop out of first window 302, and/or by other techniques. In some implementations, input provided by a user via first window 302 may facilitate implementation of operation E0 (see, e.g., FIG. 2) by first component 108 of machine-readable instructions 104 of device 102 (see, e.g., FIG. 1) as presented herein.

In some implementations, a user may provide input via first window 302 to position the various video streams to be stitched. By way of non-limiting example, a user may position the selected video stream in accordance with one or more of temporal order of the video streams, pairs of the video streams that may be used to generate a 360 degree view of an environment, and/or other criteria. Individual ones of the selected video stream within first window 302 may be represented by one or more of an thumbnail image (e.g., 304, 306, 308, and/or 310), a name associated with the video streams, and/or other information. Individual ones of the video streams may be viewed in full, in an independent manner, within first window 302 through one or more of play, pause, rewind, and/or other user interface elements.

In some implementations, user interface 300 may be configured to facilitate obtaining user input of temporal limits of the stitching of the video streams. The temporal limits may comprise one or more of a reference start time instance, a reference end time instance, and/or reference time instances. By way of non-limiting example, timeline 314 may represent a temporal span of a reference video stream with which other ones of the video streams may be synchronized to. The user may provide input to position one or more of first adjustable element 316 representing a reference end time along the timeline 314, third adjustable element 320 representing a reference start time along the timeline 314, and/or provide other input. In some implementations, input provided by a user via one or more of timeline 314, first adjustable element 316, second adjustable element 320, and/or other input may facilitate implementation of operation E05 of method 200 (see, e.g., FIG. 2) by first component 108 of machine-readable instructions 106 of device 102 (see, e.g., FIG. 1).

In some implementations, user interface 300 may be configured to receive user input of positioning second adjustable element 318 along timeline 314. The positioning of second adjustable element 318 may correspond to a selection of a reference time instance. By way of non-limiting example, positioning of second adjustable element 318 may facilitate implementation of one or more of operations E30, E3, and/or E4 of method 200 (see, e.g., FIG. 2) by one or both of third component 112 and/or fourth component 114 of machine-readable instructions 106 of device 102 (see, e.g., FIG. 1).

In accordance with one or more of operations E30, E3, E4, and/or E45, values of parameters for generating a panoramic images may be determined. The panoramic image may be generated that may comprise a combination of images from individual video streams that correspond to the reference time instance selected via user interaction with second adjustable element 318. The panoramic image may be presented in second window 324 as represented by image 322.

If the panoramic image is not satisfactory and/or if the user wishes to undertake one or more further implementations of operations E30, E3, and/or E4 the user may reposition second adjustable element 318 over timeline 314 to define another reference time instance and/or redo a panoramic image generation. The user may repeat these steps to generate a plurality of panoramic images displayed in second window 324. The user may select a panoramic image from among the plurality of panoramic images displayed din second window 324. The user's selection of a panoramic image within second window 324 may facilitate storing values for parameters that correspond to the selected panoramic image. By way of non-limiting example, user selection of a panoramic image may facilitate implementation of operation E45 of method 200 (see, e.g., FIG. 2) by one or both of third component 112 and/or fourth component 114 of machine-readable instructions 106 of device 102 (see, e.g., FIG. 1).

In some implementations, user interface 300 and/or another user interface may include a menu and/or options which may allow a user to modify values of parameters at a more detailed level.

In some implementations, a wide field video generated based on the stored values of parameters may be displayed in third window 312. By way of non-limiting example, third window 312 may include interface elements comprising one or more of pause, play, rewind, and/or other elements to facilitate viewing of the wide field video.

The wide field video stream generated by the stitching method such as described previously exhibits the advantage of offering a video stream comprising a greater quantity of information than that of a simple prior art video, obtained by a single camera, and makes it possible, with the aid of a suitable reader, to offer richer viewing of a filmed scene than that which can easily be achieved with the existing solutions.

One or more implementations of method described herein may be particularly advantageous for one or more of the following applications, cited by way of no limiting examples.

In some implementations, system 100 of FIG. 1 may be particularly suitable for filming an event combining a packed crowd, such as one or more of a concert, a sports event in a stadium, a family celebration such as a wedding, and/or other events. In the case of a concert, multi-camera holder 126 may be positioned on a stage. The positioning of multi-camera holder 126 may facilitate filming performers and audience simultaneously. In a similar manner, one or more multi-camera holder(s) 126 may be disposed within an enclosure of a stadium, to make it possible from a single viewpoint to simultaneously film the whole of the enclosure, a sports field and/or an audience public.

In some implementations, system 100 with multi-camera holder 126 may provide benefits with respect to an “onboard” application. By way of non-limiting example, an onboard application may including fastening multi-camera holder 126 to a person and/or mobile apparatus. By way of non-limiting example, multi-camera holder 126 may be fastened on a helmet of a sportsman during an event, during a paraglider flight, a parachute jump, a climb, a ski descent, and/or fastened in other manners. In some implementations, multi-camera holder may be disposed on a vehicle, such as a bike, a motorbike, a car, and/or other vehicle.

In some implementations, multi-camera holder 126 may be associated with a drone, a helicopter, and/or other flying vehicle to obtain a complete aerial video, allowing a wide field recording of a landscape, of a tourist site, of a site to be monitored, of a sports event viewed from the sky, and/or other environment. One or more applications may serve for a tele-surveillance system.

In FIG. 1, device 102, multi-camera holder 126, cameras 127, and/or external resources 128 may be operatively linked via one or more electronic communication links. For example, such electronic communication links may be established, at least in part, via a network 124. By way of non-limiting example, network may comprise or wired and/or wireless communication media. By way of non-limiting example, network 124 may comprise one or more of the Internet, Wi-Fi, Bluetooth, wired USB connection, and/or other communication media. It will be appreciated that this is not intended to be limiting and that the scope of this disclosure includes implementations in which device 102, multi-camera holder 126, cameras 127, and/or external resources 128 may be operatively linked via some other communication media.

The external resources 128 may include sources of information, hosts, external entities participating with system 100, and/or other resources. In some implementations, some or all of the functionality attributed herein to external resources 128 may be provided by resources included in system 100.

The device 102 may include communication lines or ports to enable the exchange of information with network 124 and/or other computing platforms. Illustration of device 102 in FIG. 1 is not intended to be limiting. The device 102 may include a plurality of hardware, software, and/or firmware components operating together to provide the functionality attributed herein to device 102. For example, device 102 may be implemented by a cloud of computing platforms operating together as device 102.

Memory 122 may comprise electronic storage media that electronically stores information. The electronic storage media of memory 122 may include one or both of device storage that is provided integrally (i.e., substantially non-removable) with device 102 and/or removable storage that is removably connectable to device 102 via, for example, a port or a drive. A port may include a USB port, a firewire port, and/or other port. A drive may include a disk drive and/or other drive. Memory 122 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The memory 122 may include one or more virtual storage resources (e.g., cloud storage, a virtual private network, and/or other virtual storage resources). The memory 122 may store software algorithms, information determined by processor(s) 104, information received from device 102, information received from multi-camera holder 126 and/or cameras 127, and/or other information that enables device 102 to function as described herein.

Processor(s) 104 is configured to provide information-processing capabilities in device 102. As such, processor(s) 104 may include one or more of a digital processor, an analog processor, a digital circuit designed to process information, an analog circuit designed to process information, a state machine, and/or other mechanisms for electronically processing information. Although processor(s) 104 is shown in FIG. 1 as a single entity, this is for illustrative purposes only. In some implementations, processor(s) 104 may include one or more processing units. These processing units may be physically located within the same device, or processor(s) 104 may represent processing functionality of a plurality of devices operating in coordination. The processor(s) 104 may be configured to execute components 108, 110, 112, 114, 116, 118, and/or 120. Processor(s) 104 may be configured to execute components 108, 110, 112, 114, 116, 118, and/or 120 by software; hardware; firmware; some combination of software, hardware, and/or firmware; and/or other mechanisms for configuring processing capabilities on processor(s) 104.

It should be appreciated that although components 108, 110, 112, 114, 116, 118, and/or 120 are illustrated in FIG. 1 as being co-located within a single processing unit, in implementations in which processor(s) 104 includes multiple processing units, one or more of components 108, 110, 112, 114, 116, 118, and/or 120 may be located remotely from the other components. The description of the functionality provided by the different components 108, 110, 112, 114, 116, 118, and/or 120 described above is for illustrative purposes and is not intended to be limiting, as any of components 108, 110, 112, 114, 116, 118, and/or 120 may provide more or less functionality than is described. For example, one or more of components 108, 110, 112, 114, 116, 118, and/or 120 may be eliminated, and some or all of its functionality may be provided by other ones of components 108, 110, 112, 114, 116, 118, 120, and/or other components. As another example, processor(s) 104 may be configured to execute one or more additional components that may perform some or all of the functionality attributed to one of components 108, 110, 112, 114, 116, 118, and/or 120.

It is noted that operations of method 200 in FIG. 2 are intended to be illustrative. In some implementations, method 200 may be accomplished with one or more additional operations not described, and/or without one or more of the operations discussed. Additionally, the order in which the operations of method 200 are illustrated in FIG. 2 and described herein is not intended to be limiting.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A method of stitching together video streams to generate a wide field video stream, the method being implemented in a computer system comprising one or more physical processors and storage media storing machine-readable instructions, the method comprise:
determining at least one reference time instance within a reference video stream;
determining a first set of values of parameters used to generate a first panoramic image, the first panoramic image comprising a combination of images from individual video streams that correspond to the at least one reference time instance; and
generating panoramic images that comprise images of individual video streams that correspond to individual time instances within the video streams, the panoramic images being generated based on the first set of values of the parameters, wherein individual ones of the generated panoramic images are provided as a frame of the wide field video stream.

2. The method of claim 1, further comprising:
evaluating a quality of the first panoramic image; and
responsive to the quality of the first panoramic image being unsatisfactory:
determining at least one other reference time instance within the reference video stream;
determining a second set of values of parameters used to generate a second panoramic image, the second panoramic image comprising images from individual video streams that correspond to the at least one other reference time instance; and
generating the panoramic images based on the second set of values and not the first set of values.

3. The method of claim 1, wherein the at least one reference time instance comprises a first reference time instance, the first reference time instance being determined based on user input into a user interface, the first panoramic image comprising a combination of images from individual video streams that correspond to the first reference time instance, and wherein the method further comprises:
effectuating presentation of the first panoramic image on the user interface.

4. The method of claim 1, wherein the at least one reference time instance comprises a first reference time instance, and wherein the method further comprises:
determining a set of reference time instances distributed around the first reference time instance;
determining intermediate sets of values of parameters used to generate intermediate panoramic images, individual ones of the intermediate panoramic images comprising a combination of images from individual video streams that correspond to individual ones of the reference time instances in the set of reference time instances;
determining a second set of values of the parameters based on averaging values included in the intermediate sets of values for individual ones of the parameters; and
generating the panoramic images based on the second set of values and not the first set of values.

5. The method of claim 1, wherein the at least one reference time instance comprises a plurality of reference time instances, the plurality of reference time instances being within a predetermined duration of the reference video stream, and wherein the method further comprises:
determining intermediate sets of values of parameters used to generate intermediate panoramic images, individual ones of the intermediate panoramic images comprising a combination of images from individual video streams that correspond to individual ones of the reference time instances in the plurality of reference time instances;
determining a second set of values of parameters based on averaging values included in the intermediate sets of values for individual ones of the parameters; and
generating the panoramic images based on the second set of values and not the first set of values.

6. The method of claim 1, further comprising repeating the following operations for individual time instances sequentially over a duration of the reference video stream:
decoding, from the video streams, individual images corresponding to a given time instance within the individual video streams;
generating a given panoramic image using decoded images that correspond to the given time instance; and
generating the wide field video stream by providing the given panoramic image as a given frame of the wide field video stream.

7. The method of claim 6, further comprising video coding the wide field video stream either at the end of each iteration of the repeated operations, or at the end of a set of iterations.

8. The method of claim 1, further comprising:
determining a temporal offset between individual ones of the video streams and the reference video stream based on audio information associated with individual ones of the video streams, the determination being based on identifying an identical sound within audio information of the video streams; and
synchronizing the video streams based on the temporal offset by associating individual images within individual video streams with other individual images within the reference video stream that are closest in time.

9. The method of claim 8, further comprising:
obtaining user selection of a start time instance and an end time instance within the reference video stream.

10. The method of claim 1, further comprising obtaining audio information associated with at least one of the video streams; and
providing the audio information as audio information for the wide field video stream.

11. The method of claim 1, further comprising:
positioning at least one multi-camera holder, the positioning comprising one or more of level with an event stage, in a sporting arena, on an athlete during a sporting event, on a vehicle, on a drone, or on a helicopter;
obtaining the video streams from visual information captured by cameras fastened on the at least one multi-camera holder; and
presenting, on at least one display space of at least one screen, the wide field video stream.

12. A device configured for stitching together video streams to generate a wide field video stream, the device comprising:
a memory; and
one or more physical processors configured by machine-readable instructions to:
determine at least one reference time instance within a reference video stream;
determine a first set of values of parameters used to generate a first panoramic image, the first panoramic image comprising a combination of images from individual video streams that correspond to the at least one reference time instance; and
generate panoramic images that comprise images of individual video streams that correspond to individual time instances within the video streams, the panoramic images being generated based on the first set of values of the parameters, wherein individual ones of the panoramic images are provided as a frame of the wide field video stream.

13. The device of claim 12, wherein the one or more physical processors are further configured by machine-readable instructions to:
effectuate presentation of a user interface, the user interface being configured to receive user input of the at least one reference time instance.

14. The device of claim 13, wherein the user interface comprises one or more of:
a first window configured for presenting video streams for stitching, and having a functionality enabling video streams to be added or removed;
one or more user interface elements configured for receiving user input of one or more of the at least one reference time instance, a reference start time instance, or a reference end time instance within the reference video stream;
a second window configured for presenting the first panoramic image; or
a third window configured for presenting the wide field video stream.

15. The device of claim 12, wherein the one or more physical processors are further configured by machine-readable instructions to:
evaluate a quality of the first panoramic image; and
responsive to the quality of the first panoramic image being unsatisfactory:
determine at least one other reference time instance within the reference video stream;
determine a second set of values of parameters used to generate a second panoramic image, the second panoramic image comprising images from individual video streams that correspond to the at least one other reference time instance; and
generate the panoramic images based on the second set of values and not the first set of values.

16. The device of claim 12, wherein the at least one reference time instance comprises a first reference time instance, and wherein the one or more physical processors are further configured by machine-readable instructions to:
determine a set of reference time instances distributed around the first reference time instance;
determine intermediate sets of values of parameters used to generate intermediate panoramic images, individual ones of the intermediate panoramic images comprising a combination of images from individual video streams that correspond to individual ones of the reference time instances in the set of reference time instances;
determine a second set of values of the parameters based on averaging values included in the intermediate sets of values for individual ones of the parameters; and
generate the panoramic images based on the second set of values and not the first set of values.

17. A system for stitching video streams, the system comprising:
a device configured to stitching together video streams, the device comprising:
a memory;
one or more physical processors configured by machine-readable instructions to:
determine at least one reference time instance within a reference video stream;
determine a first set of values of parameters used to generate a first panoramic image, the first panoramic image comprising a combination of images from individual video streams that correspond to the at least one reference time instance; and
generate panoramic images that comprise images of individual video streams that correspond to individual time instances within the video streams, the panoramic images being generated based on the first set of values of the parameters, wherein individual ones of the panoramic images are provided as a frame of the wide field video stream; and
a multi-camera holder, the multi-camera holder comprising at least two housings for fastening cameras, wherein two of the at least two housings are configured such that two adjacent cameras fastened to the two housings are oriented substantially perpendicular to one another.

18. The system of claim 17, further comprising a reader, the reader being configured to read the wide field video stream resulting from the generated panoramic images.

19. The system of claim 17, wherein the one or more physical processors are further configured by machine-readable instructions to:
evaluate a quality of the first panoramic image; and
responsive to the quality of the first panoramic image being unsatisfactory:
determine at least one other reference time instance within the reference video stream;
determine a second set of values of parameters used to generate a second panoramic image, the second panoramic image comprising images from individual video streams that correspond to the at least one other reference time instance; and
generate the panoramic images based on the second set of values and not the first set of values.

20. The system of claim 17, wherein the at least one reference time instance comprises a first reference time instance, and wherein the one or more physical processors are further configured by machine-readable instructions to:
determine a set of reference time instances distributed around the first reference time instance;
determine intermediate sets of values of parameters used to generate intermediate panoramic images, individual ones of the intermediate panoramic images comprising a combination of images from individual video streams that correspond to individual ones of the reference time instances in the set of reference time instances;
determine a second set of values of the parameters based on averaging values included in the intermediate sets of values for individual ones of the parameters; and
generate the panoramic images based on the second set of values and not the first set of values.
